(19) United States
(12) Patent Application Publication
(10) Pub. No.: US 2025/0367700 A1
(43) Pub. Date: Dec. 4, 2025

(54) Paint Gun Support and Paint Collection Device

(71) Applicant: Bridget Cardenas, Tujunga, CA (US)

(72) Inventor: Bridget Cardenas, Tujunga, CA (US)

(21) Appl. No.: 19/211,980

(22) Filed: May 19, 2025

Related U.S. Application Data
(60) Provisional application No. 63/652,714, filed on May 29, 2024.

(51) Int. Cl. B05B 15/62

(52) U.S. Cl. CPC B05B 15/62

(57) ABSTRACT

A paint gun support and paint collection device is provided. The device is configured to stabilize a gravity feed paint gun in an upright, freestanding position while providing an integrated tray system for paint collection and drainage. The device comprises a support member with a flat base and a pair of opposing arms arranged in an inverted V-shape, each arm designed to contact and secure opposite sides of the paint gun. The arms may be joined by a connecting member having cutouts shaped to receive features of the paint gun, enhancing positional stability. In one embodiment, the tray includes an optional removable liner constructed from solvent-resistant materials to facilitate cleanup and prevent paint buildup. Integrated into the upper region of the tray is a straining area comprised of a divider configured to support cheesecloth or similar filtration media, allowing drained paint to flow directly into the tray below.

### CROSS REFERENCE TO RELATED APPLICATION

The present application claims priority to, and the benefit of, U.S. Provisional Application No. 63/652,714, which was filed on May 29, 2024, and is incorporated herein by reference in its entirety.

### FIELD OF THE INVENTION

The present invention relates generally to the field of painting. More specifically, the present invention relates to a device configured to stabilize a gravity feed paint gun in an upright, freestanding position with a tray positioned below that includes an optional removable liner for cleanup and a straining area with a divider for filtration media, directing drained paint into the tray. Accordingly, the present disclosure makes specific reference thereto. Nonetheless, it is to be appreciated that aspects of the present invention are also equally applicable to other like applications, devices, and methods of manufacture.

### BACKGROUND

Gravity feed paint guns are widely used in professional and hobbyist painting applications due to their efficient paint delivery and precision control. However, their top-heavy design presents a recurring challenge during the refilling process. When placed on a flat surface, the weight distribution of the paint gun causes it to become unstable, often tipping over and resulting in paint spillage. This not only leads to wasted materials but also increases the time required for setup and cleanup. Painters are frequently forced to improvise support structures or rely on additional tools to hold the gun upright while refilling, adding to the complexity and reducing overall workflow efficiency. Additionally, paint is commonly strained through cheesecloth or similar filtration media before being transferred into the gun, but without a designated area to position the strainer, this process becomes cumbersome and prone to mess. Strained paint frequently spills over or drips onto surrounding surfaces due to the absence of a proper containment system, further compounding cleanup efforts. These issues can lead to material loss, inconsistent application quality due to unfiltered particulates, and increased labor. Despite the widespread use of gravity feed paint guns, there remains a lack of integrated support and containment solutions designed specifically for these tools.

Therefore, there exists a long-felt need in the art for a paint gun support and paint collection device that enables hands-free stabilization of a gravity feed paint gun in an upright position. There also exists a long-felt need in the art for a paint gun support and paint collection device that provides integrated containment of drips and spillage during the refilling process. Moreover, there exists a long-felt need in the art for a paint gun support and paint collection device that includes a structured straining area for draining paint from a cheesecloth or similar medium into a defined receptacle below.

The subject matter disclosed and claimed herein, in one embodiment thereof, comprises a paint gun support and paint collection device. The device is configured to stabilize a gravity feed paint gun in an upright, freestanding position while providing an integrated tray system for paint collection and drainage. The device comprises a support member with a flat base and a pair of opposing arms arranged in an inverted V-shape, each arm designed to contact and secure opposite sides of the paint gun. The arms may be joined by a connecting member having cutouts shaped to receive features of the paint gun, enhancing positional stability. In one embodiment, the tray includes an optional removable liner constructed from solvent-resistant materials to facilitate cleanup and prevent paint buildup. Integrated into the upper region of the tray is a straining area comprised of a divider configured to support cheesecloth or similar filtration media, allowing drained paint to flow directly into the tray below.

In this manner, the paint gun support and paint collection device of the present invention accomplishes all the forgoing objectives and provides a stable upright support for gravity feed paint guns that allows users to perform refilling and temporary storage operations. The tray positioned below the gun captures drips and spillage, reducing cleanup time and material waste. The inclusion of a straining area designed for cheesecloth or similar materials ensures that painters have a designated place to drain filtered paint without introducing mess or requiring separate tools. By integrating stabilization, spill containment, and filtration drainage into a single system, the invention addresses key operational challenges and increases efficiency for end users.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a paint gun support and paint collection device. The device stabilizes a paint gun in an upright position and integrates support for paint straining and drip containment, enabling hands-free operation during refilling and reducing cleanup requirements.

The device is comprised of a support member configured to cradle a gravity feed paint gun in a free-standing, upright orientation. The support member includes a pair of opposing arms arranged in an inverted V-shape to provide lateral rigidity and resist deformation. The arms may be fabricated from structurally stable materials such as stamped metal or molded polymer and may vary in shape to accommodate different paint gun geometries while enhancing stability and surface contact.

The paint gun is supported between the opposing arms of the support member, which may be connected via a connecting member containing a shaped cutout for engaging a portion of the paint gun. A flat base member enables the support member to remain upright independently. Grip elements may be applied to outer surfaces to prevent displacement of the paint gun during use.

The device is further comprised of at least one tray positioned beneath the suspended paint gun to capture drips. The tray body may include a non-slip bottom and raised sidewalls contoured to direct fluid to the center. Interior corners may be filleted to ease cleaning and promote full drainage.

The tray may include a peripheral lip to redirect stray drips and a removable inner liner made from solvent-resistant, low-adhesion materials to facilitate cleaning. The liner may be disposable or reusable and may include textured or coated surfaces to minimize paint buildup.

A straining area may be integrated above the tray, comprising a divider formed from grid or mesh material. The divider supports filtration media and allows paint to flow into the tray below. The straining section may be formed at a fixed decline to facilitate passive drainage.

The support member may be configured to surround the tray or may be detachably joined using fastening systems including rail mounts, magnetic fasteners, threaded fasteners, or snap-fit fasteners, applied singly or in combination based on user or manufacturing needs.

A method of using the device includes inserting a paint gun between the arms of the support member for hands-free stabilization, positioning a tray underneath to collect drips, optionally inserting a removable liner within the tray, and optionally placing a cheesecloth in the straining area to direct paint into the tray. After use, the paint gun is removed and the tray or liner is cleaned or disposed of.

Accordingly, the paint gun support and paint collection device of the present invention is particularly advantageous as it provides a stable upright support for gravity feed paint guns that allows users to perform refilling and temporary storage operations. The tray positioned below the gun captures drips and spillage, reducing cleanup time and material waste. The inclusion of a straining area designed for cheesecloth or similar materials ensures that painters have a designated place to drain filtered paint without introducing mess or requiring separate tools. By integrating stabilization, spill containment, and filtration drainage into a single system, the invention addresses key operational challenges and increases efficiency for end users.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side perspective view of one potential embodiment of a paint gun support and paint collection device of the present invention while supporting a paint gun in accordance with the disclosed architecture;

FIG. 2 illustrates a perspective view of one potential embodiment of a paint gun support and paint collection device of the present invention while supporting a paint gun in accordance with the disclosed architecture;

FIG. 3 illustrates a side perspective view of a removable liner of one potential embodiment of a paint gun support and paint collection device of the present invention in accordance with the disclosed architecture;

FIG. 4 illustrates a front view of a support member of one potential embodiment of a paint gun support and paint collection device of the present invention in accordance with the disclosed architecture; and

FIG. 5 illustrates a flowchart of a method of using one potential embodiment of a paint gun support and paint collection device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a paint gun support and paint collection device that enables hands-free stabilization of a gravity feed paint gun in an upright position. There also exists a long-felt need in the art for a paint gun support and paint collection device that provides integrated containment of drips and spillage during the refilling process. Moreover, there exists a long-felt need in the art for a paint gun support and paint collection device that includes a structured straining area for draining paint from a cheesecloth or similar medium into a defined receptacle below.

The present invention, in one exemplary embodiment, is comprised of a paint gun support and paint collection device. The device maintains a paint gun in an upright position while providing integrated functionality for paint straining and drip containment, thereby allowing hands-free refilling and minimizing cleanup efforts.

The device is comprised of a support member designed to cradle a gravity feed paint gun in an upright, free-standing configuration. The support member incorporates a pair of opposing arms arranged in an inverted V-shape to enhance lateral rigidity and resist deformation. The arms may be formed from structurally stable materials such as stamped metal or molded polymer and may vary in geometry to fit a range of paint gun shapes while increasing stability and surface engagement.

The paint gun is held between the opposing arms of the support member, which may be interconnected by a connecting member featuring a shaped cutout to accommodate a portion of the paint gun. A flat base member allows the support structure to remain upright without external support. Grip elements may be applied to the outer surfaces to prevent movement of the paint gun once inserted.

The device additionally includes at least one tray positioned below the suspended paint gun to collect drips. The tray body may be comprised of a non-slip base and raised sidewalls shaped to guide liquid toward the center. Interior corners may be filleted to simplify cleaning and promote complete drainage.

A peripheral lip may be incorporated into the tray to redirect stray drips, and a removable inner liner made from solvent-resistant, low-adhesion material may be used to ease cleanup. The liner may be reusable or disposable and may feature textured or coated surfaces to reduce paint adhesion.

A straining section may be positioned above the tray, comprised of a divider constructed from mesh or grid material. This divider supports filtration media and allows filtered paint to drain into the tray. The straining area may be inclined at a fixed angle to encourage passive flow and reduce pooling.

The support member may either surround the tray or be detachably connected to it through fastening systems such as rail mounts, magnetic couplings, threaded fasteners, or snap-fit mechanisms. These connection methods may be used individually or in combination to suit user or manufacturing requirements.

The method of using the device involves inserting a paint gun between the support arms to stabilize it, placing a tray underneath to catch drips, optionally inserting a removable liner, and optionally using a cheesecloth within the straining section to direct filtered paint into the tray. Following use, the paint gun is removed, and the tray or liner is either cleaned or discarded.

As a result, the paint gun support and paint collection device described herein offers significant benefits by providing stable upright support for gravity feed paint guns, facilitating refilling and temporary storage. The underlying tray captures spills, minimizing cleanup time and material waste. The integrated straining section accommodates filtration media such as cheesecloth, allowing clean drainage without the need for additional tools. By combining stabilization, drip containment, and straining functionality into one system, the invention addresses multiple operational needs and enhances overall efficiency for users.

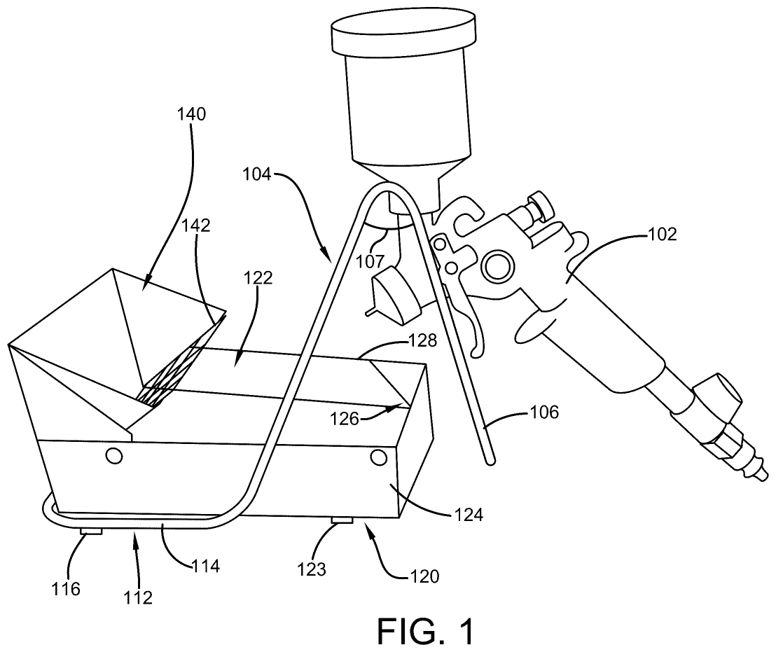

Referring initially to the drawings, FIG. 1 illustrates a side perspective view of one potential embodiment of a paint gun support and paint collection device 100 of the present invention while supporting a paint gun in accordance with the disclosed architecture. The device 100 stabilizes a paint gun 102 in an upright position and provides integrated support for paint straining and drip containment, streamlining the refilling process and reducing cleanup requirements while painting. The configuration of the device 100 enhances user efficiency by allowing hands-free stabilization of the paint gun 102 during the straining and refilling operations.

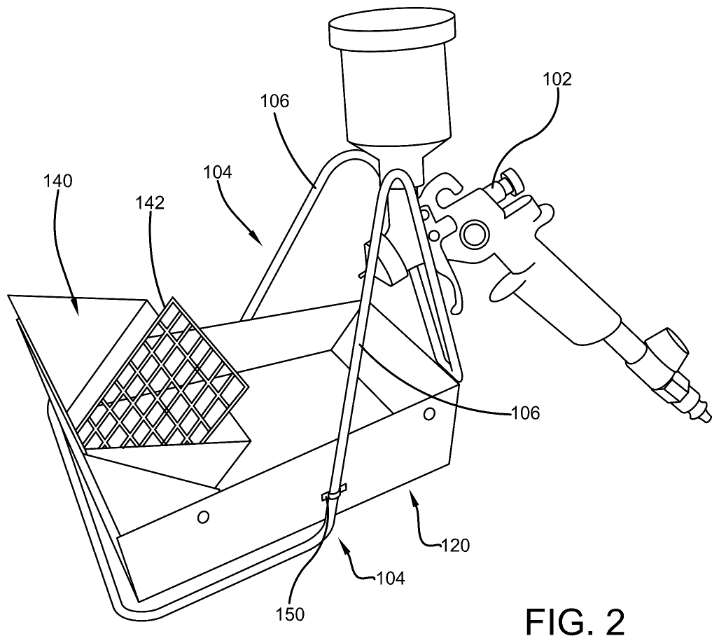

The device 100 is comprised of a support member 104 configured to cradle and support a gravity feed paint gun 102 (or other similar device) in a relatively upright and free-standing position, as seen in FIG. 1 and FIG. 2. In one embodiment, the support member 104 may include a pair of opposing arms 106, each arm comprised of arranged an angle 107 that forms an inverted V-shape. The V-shape may provide lateral rigidity and resistance to deformation under the weight of the suspended paint gun 102. Each arm 106 may be constructed from stamped metal, injection-molded polymer, or other structurally stable material to ensure sufficient load-bearing capacity. In various embodiments, the support member 104 and the arms 106 may be any shape such as but not limited to U-shapes, arcuate forms, offset brackets, or contoured geometries configured to accommodate the diverse shapes, reservoir configurations, and dimensional profiles of different paint guns 102. The geometry of the arms 106 may be selected to maximize surface contact with the paint gun 102 body or reservoir, enhance mechanical stability, and reduce the risk of tipping during use.

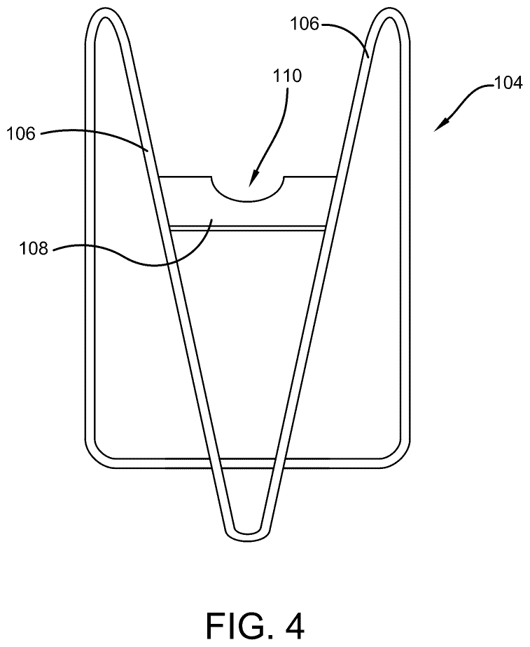

During use, a paint gun 102 can be placed between the members 104, wherein the members 104 support contact both sides of the gun 102 to support the gun 102. In one embodiment, the arms 106 may be connected via a connecting member 108 having at least one cutout 110 (as seen in FIG. 4) specifically shaped to receive a portion of the gun 102.

The member 104 preferably has a flat base member 112 that allows the support member 104 to be free-standing. The member 104 may be made of any material. In one embodiment, various outer surfaces 114 of the member 104 may be comprised of a grip element 116 such as but not limited to a non-slip grip material, a texture, etc. to prevent lateral or vertical displacement of the paint gun 102 once inserted into the member 104. The grip element 116 may include molded ridges, embedded silicone patterns, spray-applied coatings, etc. to enhance tactile engagement between the member 104 and the paint gun 102.

The device 100 may also be comprised of at least one tray 120, as seen in FIG. 1 and FIG. 2. The tray 120 can be positioned underneath a gun 102 while the gun is suspended from the member 104 to catch any drips. The body 122 of the tray 120 may be made from any material and may be any shape. In one embodiment, the body 122 is comprised of a non-slip bottom surface/feet 123 to anchor the tray 120 against sliding forces.

The body 122 is comprised of raised sidewalls 124 that may surround the entire tray 120 perimeter, with a height sufficient to retain overflow volumes and prevent fluid migration. The raised sidewalls 124 may be contoured or chamfered to direct runoff toward the center of the tray 120, minimizing the risk of spillover. Interior corners 126 of the body 122 may be filleted or radiused to allow easier cleaning and to inhibit fluid retention in sharp recesses. The radiused profile may also reduce surface tension effects, encouraging full drainage of residual paint.

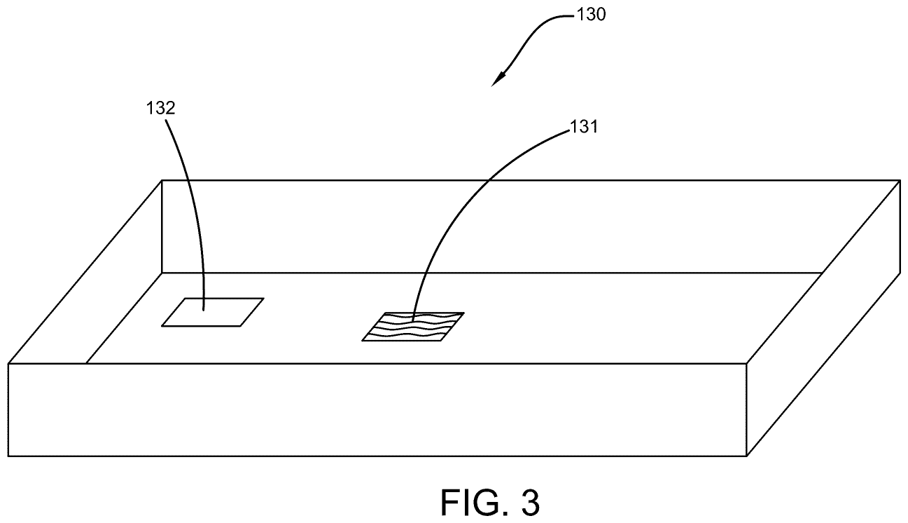

The body 122 may be comprised of a peripheral lip 128 to capture and redirect stray drips back into the body 122. The tray 120 may also include a removable inner liner 130 (as seen in FIG. 3) placed within the body 122. The liner 130 itself may be fabricated from lightweight, solvent-resistant materials and include surface textures 131 or coatings 132 that minimize paint adhesion, such as but not limited to polytetrafluoroethylene (PTFE), silicone-based release layers, etc.

The liner 130 may be comprised of flexible thermoplastic sheets, disposable polymer film, reusable silicone mats, etc. The liner 130 may be used independently or in conjunction with the body 122 to reduce cleaning time and protect the tray body from residue accumulation or chemical exposure.

The tray 120 may also be comprised of a straining area 140 designed for use with cheesecloth or comparable filtration media commonly used by painters. This area 140 is preferably positioned above the body 122 and includes a divider 142. The divider 142 is preferably a grid or mesh support, constructed from stainless steel, rigid polymer, perforated aluminum, etc., allowing strained material from the area 140 to flow into the body 122 below. The opening size and support spacing of the divider 142 may vary and may be selected based on common paint viscosities and particulate sizes encountered during use. In one embodiment, the straining section 140 is formed at a fixed decline, such as but not limited to between 3° and 100 relative to a horizontal axis of the body 122, to promote passive flow and reduce pooling.

In one embodiment, the member 104 fits around the tray 120. In another embodiment, the tray 120 and member 104 may be detachably joined using one or more fastening systems 150, such as but not limited to slide-in rail mounts along the body 122 that receive the member 104, magnetic fasteners, threaded fasteners, snap-fit fasteners, etc. Each of these connection methods may be implemented individually or in combination, depending on the intended user environment, manufacturing requirements, or desired adjustability.

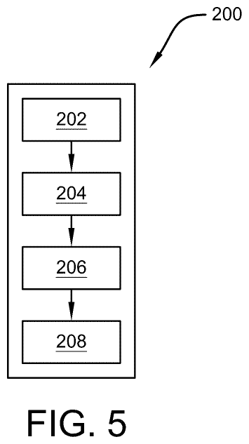

The present invention is also comprised of a method of using 200 the device 100, as seen in FIG. 5. First, a device 100 is provided comprised of a support member 104 having a pair of opposing arms 106 arranged in an inverted V-shape and a flat base member 112, wherein the support member 104 is configured to cradle and stabilize a paint gun 102 in an upright position [Step 202]. Then, a paint gun 102 is inserted between the arms 106 such that both arms 106 contact opposing sides of the paint gun 102, supporting it in a hands-free, freestanding orientation [Step 204]. Next, a tray 120 is positioned underneath the suspended paint gun 102, wherein the tray 120 is comprised of a body 122 to collect drips and reduce residue buildup [Step 206]. Optionally, an inner liner 130 is placed within the body 122 prior to use to protect the tray 120 from paint accumulation and is removed after use for cleaning or disposal [Step 208]. Furthermore, with the paint gun 102 supported in the support member 104, paint may be optionally poured into the gun 102 [Step 210]. Finally, after refilling and straining operations are complete, the paint gun 102 is removed from between the arms 106 and the tray 120 is cleaned or emptied as needed [Step 214]. A cheesecloth can also be placed within a straining area 140 positioned above the tray 120 to permit residual paint from the cheesecloth to flow into the body 122 below [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “paint gun support and paint collection device” and “device” are interchangeable and refer to the paint gun support and paint collection device 100 of the present invention.

Notwithstanding the foregoing, the paint gun support and paint collection device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the paint gun support and paint collection device 100 as shown in the FIGS. are for illustrative purposes only, and that many other sizes and shapes of the paint gun support and paint collection device 100 are well within the scope of the present disclosure. Although the dimensions of the paint gun support and paint collection device 100 are important design parameters for user convenience, the paint gun support and paint collection device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A paint gun support and paint collection device comprising:
a support member configured to cradle and support a paint gun; and
a tray positioned beneath the support member and configured to collect drips from the paint gun, the tray comprising a body having a raised sidewall and a straining area comprised of a divider.

2. The paint gun support and paint collection device of claim 1, wherein the support member comprised of a pair of opposing arms.

3. The paint gun support and paint collection device of claim 2, wherein each of the pair of opposing arms are comprised of an inverted V-shape.

4. The paint gun support and paint collection device of claim 1, wherein the body is comprised of a non-slip bottom surface.

5. The paint gun support and paint collection device of claim 1, wherein the body is comprised of a lip.

6. The paint gun support and paint collection device of claim 1, wherein an interior corner of the body is radiused.

7. The paint gun support and paint collection device of claim 1, wherein the raised sidewall is comprised of a contoured side wall.

8. The paint gun support and paint collection device of claim 1, wherein the raised sidewall is comprised of a chamfered side wall.

9. The paint gun support and paint collection device of claim 1, wherein the divider is comprised of a grip or a mesh.

10. The paint gun support and paint collection device of claim 1, wherein the support member fits around the tray.

11. A paint gun support and paint collection device comprising:
a support member configured to cradle and support a paint gun;
a tray positioned beneath the support member and configured to collect drips from the paint gun, the tray comprising a body having a raised sidewalls and a straining area comprised of a divider; and
a removable divider.

12. The paint gun support and paint collection device of claim 11, wherein the removable liner is comprised of a flexible material.

13. The paint gun support and paint collection device of claim 11, wherein the removable liner is comprised of a surface coating that minimizes paint adhesion.

14. The paint gun support and paint collection device of claim 11, wherein the body is comprised of a lip.

15. The paint gun support and paint collection device of claim 11, wherein an interior corner of the body is radiused.

16. The paint gun support and paint collection device of claim 11, wherein the raised sidewall is comprised of a contoured side wall.

17. The paint gun support and paint collection device of claim 11, wherein the raised sidewall is comprised of a chamfered side wall.

18. The paint gun support and paint collection device of claim 11, wherein the divider is comprised of a grip or a mesh.

19. The paint gun support and paint collection device of claim 11, wherein the support member fits around the tray.

20. A method of using a paint gun support and paint collection device, the method comprising the following steps:
providing a paint gun support and paint collection device comprised of a support member configured to support a paint gun and a tray positioned beneath the support member, the tray comprising a body having raised sidewalls and a straining area comprised of a divider;
inserting the paint gun into the support member such that the paint gun is supported in an upright, free-standing orientation;
positioning the tray to collect drips from the paint gun; and
removing the paint gun from the support member and cleaning or emptying the tray.
